(19) United States
(12) Patent Application Publication
(10) Pub. No.: US 2019/0153705 A1
(43) Pub. Date: May 23, 2019

(54) SYSTEMS AND METHODS FOR PROVIDING A WATER SUPPLY THROUGH IN-SITU WATER COLLECTION

(71) Applicants: Jacob Russo, New York, NY (US); Anamarija Frankic, Squantum, MA (US); C. Mike Lindsey, Brooklyn, NY (US)

(72) Inventors: Jacob Russo, New York, NY (US); Anamarija Frankic, Squantum, MA (US); C. Mike Lindsey, Brooklyn, NY (US)

(21) Appl. No.: 16/164,700

(22) Filed: Oct. 18, 2018

Related U.S. Application Data
(60) Provisional application No. 62/574,184, filed on Oct. 18, 2017.

(51) Int. Cl. E03B 3/40; B01D 53/00; B08B 7/00; E03B 3/02; E03B 5/02

(52) U.S. Cl. CPC E03B 3/40; B01D 53/002; B08B 7/0071; C02F 2103/001; E03B 3/02; E03B 5/02; B08B 7/0092

(57) ABSTRACT

Various embodiments of the present disclosure provide a system and method for harnessing in-situ water sources to provide a water supply. In an embodiment, the system comprises a collection unit and a storage unit. In the embodiment the collection unit may a capture surface configured to capture atmospheric water in an in-situ manner and transport the captured water to a periphery of the capture surface. The storage unit may have at least one cavity configured for storing the collecting water and a storage frame comprising a storage wall that extends around a periphery of the at least once cavity. In the embodiment the storage frame may be coupled to the collection unit and may be configured to transport the collected water from the collection unit to at least one cavity.

### CROSS-REFERENCE TO RELATED APPLICATIONS

The present application claims the benefit of provisional application No. 62/574,184, filed Oct. 18, 2017 and entitled, “Biomimetic System Linking In-Situ Water Sources with Urban Food Production,” the contents of which are hereby incorporated in their entirety.

### BACKGROUND OF THE INVENTION

### 1. Field of Invention

The present disclosure relates to systems and techniques for collecting atmospheric water to provide a water supply that can be used, for example, for food production, atmospheric cooling, etc.

### 2. Description of Related Art

Rapidly increasing population and urbanization coupled with significant loss of arable land due to erosion or pollution has led to an unprecedented challenge of sustainable food supply for populations. For example, with regards to food supply, the agricultural sector consumes about 70 percent of renewable freshwater resources globally. Introducing sustainable alternatives for water supply and irrigation can have a significant impact on the food cycle.

Conventional techniques attempt to slow down water runoff through buffering systems during rain and storm events. However, they have not considered an integrated, biomimetic approach to water capture, storage, filtration, and distribution, especially within the framework of urban infrastructure (e.g., urban food-water infrastructures).

### SUMMARY OF THE INVENTION

The present invention overcomes these and other deficiencies of the prior art by providing a system for harnessing in-situ water sources to provide a water supply. The water supply may be used to provide water, for example, for sustainable food production, atmospheric cooling, etc. The system may enable buildings and greenhouses in various environments to become more self-sufficient and sustainable in terms of water collection and distribution.

In some embodiments, the system includes, the system comprises a collection unit and a storage unit. In the embodiment the collection unit may a capture surface configured to capture atmospheric water in an in-situ manner and transport the captured water to a periphery of the capture surface. The storage unit may have at least one cavity configured for storing the collecting water and a storage frame comprising a storage wall that extends around a periphery of the at least once cavity. In the embodiment the storage frame may be coupled to the collection unit and may be configured to transport the collected water from the collection unit to at least one cavity.

In some embodiments, the capture surface may be configured to transport the captured atmospheric water to a lower periphery of the capture surface. The capture surface may comprise a woven mesh. The capture surface may be hydrophobic, super hydrophobic, hydrophilic, and/or super hydrophilic. The collection unit may comprise a water filtration membrane that filters water that is flowing vertically downward from the capture surface. There may be two or more cavities. The collection unit and storage unit may be modular attachable to one another and to a plurality of other collection units and storage units. The collection unit may further comprise a collection frame that extends around the periphery of the collection surface, the collection frame having a collection channel with a conduit for transporting water, wherein the conduit of the collection frame is fluidly connected to the storage frame. The storage wall may have a storage channel with a conduit for transporting water, wherein the conduit of the collection frame is fluidly connected to the conduit of the storage frame. The system may include a plurality of collection units and a plurality of storage units arranged in an array and fluidly connected to one another such that the conduits of the plurality of collection units and the conduits of the plurality of storage units provide a fluidly integrated duct system.

Also disclosed is a method of method of assembling a water collection system. The method may include providing a collection unit, the collection unit comprising a capture surface that is configured to capture atmospheric water in an in-situ manner and transport the captured atmospheric water to a periphery of the capture surface, and attaching a storage unit to the collection unit. The storage unit may include at least one cavity configured for storing the collected water, and a storage frame. The storage frame may comprise a storage wall that extends around a periphery of the at least one cavity. The storage frame may be fluidly coupled to the collection unit and is configured to transport the collected water from the collection unit to the at least one cavity. The method may include assembling a plurality of collection units and storage units in an array to form an integrated grid system.

In some embodiments, a system is disclosed. The system may include a modular frame array comprising a plurality of tubes that define a plurality of interiors, and a plurality of collection surfaces disposed within respective interiors. The collection surfaces may each be configured to capture atmospheric water in an in-situ manner and transport the captured atmospheric water to a periphery of the capture surface. The water collection from the collection surfaces may flow into an interior conduit of the tubes, and the tubes may be fluidly connected to provide an integrated duct system within the modular frame. The capture surfaces may be configured to transport the captured atmospheric water to a lower periphery of the capture surface.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 is a front view of a water collection system, according to an embodiment;

FIG. 2 is a perspective view of an array of water collection systems of FIG. 1 arranged on an exterior of a greenhouse, according to an embodiment;

FIG. 3A is a front view of a collection frame, according to an embodiment;

FIG. 3B is a cross-sectional view of a attachment portion of the collection frame of FIG. 3A, according to an embodiment;

FIG. 3C is a front view of a storage unit, according to an embodiment;

FIG. 3D is a cross-sectional view of a attachment portion of the collection frame of FIG. 3C, according to an embodiment;

FIG. 4A is a front view of a rear piece of a collection frame and a rear piece of a storage frame, according to an embodiment;

FIG. 4B is a front view of a front piece of the collection frame of FIG. 4A and a front piece of the storage frame of FIG. 4A, according to an embodiment;

FIG. 4C is a front view of an attachment component that may connect the collection frame and the storage frame shown in FIGS. 4A and 4B; according to an embodiment;

FIG. 5A is a perspective view of the rear pieces of the collection and storage frames of FIG. 4A, according to an embodiment;

FIG. 5B is a perspective view of the rear and front pieces of the collection and storage frames of FIGS. 4A and 4B before they are attached, according to an embodiment;

FIG. 5C is a perspective view of the rear and front pieces of the collection frame of FIGS. 4A and 4B attached to one another, and the rear and front pieces of the storage frame of FIGS. 4A and 4B attached to one another, according to an embodiment;

FIG. 5D is a perspective view of a portion of the frames of FIG. 5A-5C, showing a [pipe] disposed between the front and rear pieces, according to an embodiment;

FIG. 5E is a perspective view of a portion of the frames of FIG. 5A-5C, showing a connection portion, according to an embodiment;

FIG. 5F is a perspective view of a portion of the frames of FIGS. 5A-5C, showing an aperture, according to an embodiment;

FIG. 5G is a perspective view of the portion of the frames of FIGS. 5A-5C, showing a pipe extending through the aperture shown in FIG. 5F, according to an embodiment;

FIG. 6A is a front view of a collection unit, comprising a collection surface affixed to a collection frame, according to an embodiment;

FIG. 6B is a perspective view of a portion of the collection unit of FIG. 6A, according to an embodiment;

FIG. 7A is a front view of a water collection system, according to an embodiment;

FIG. 7B is a front view of portion A of the water collection system shown in FIG. 7A, according to an embodiment;

FIG. 8 is a perspective view of the water collection system of FIGS. 7A and 7B arranged on an exterior of a shipping container, according to an embodiment;

FIG. 9 is a view of disassembled components of a water collection system, according to an embodiment;

FIG. 10 is a perspective view of a water collection system arranged on an exterior of a shipping container, according to an embodiment;

FIG. 11 is a perspective view of a portion of the water collection system arranged on the exterior of the shipping container of FIG. 10, according to an embodiment;

FIG. 12 is a side view of the water collection system arranged on the exterior of the shipping container, according to an embodiment;

FIG. 13 is a perspective view of a portion of the water collection system arranged on the exterior of the shipping container of FIG. 10, according to an embodiment;

FIG. 14A is a perspective view of a water collection system arranged on an exterior of a building structure, according to an embodiment;

FIG. 14B is a exploded view of a portion of the water collection system of FIG. 14A.

FIG. 15 is a perspective view of a water collection system, according to an embodiment; and

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EMBODIMENTS

The increasing problem of water scarcity and need for sustainable solutions to water supply (e.g., for agricultural use) is addressed with a modular, systems approach that can be integrated into architectural tectonics. This invention brings together multiple functions, supported by biomimetic principles, processes, and forms, into one system.

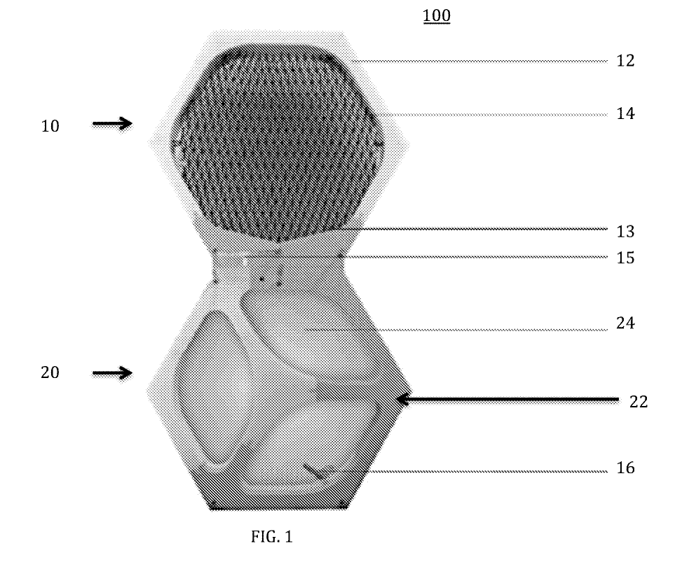

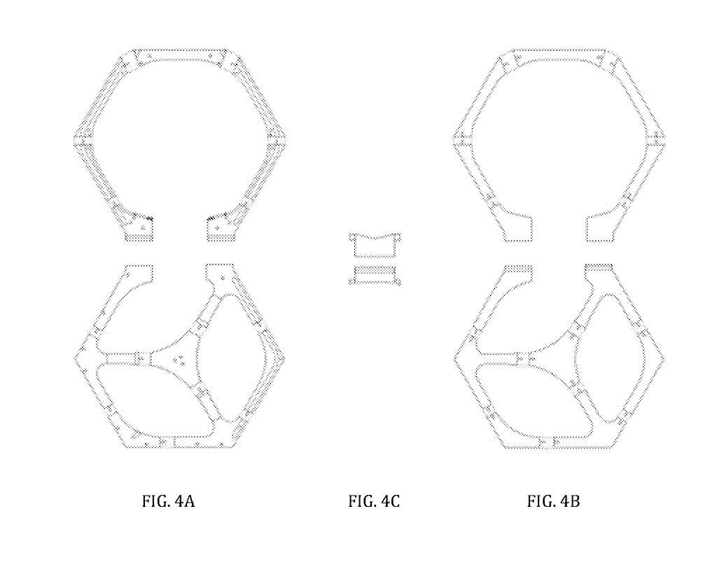

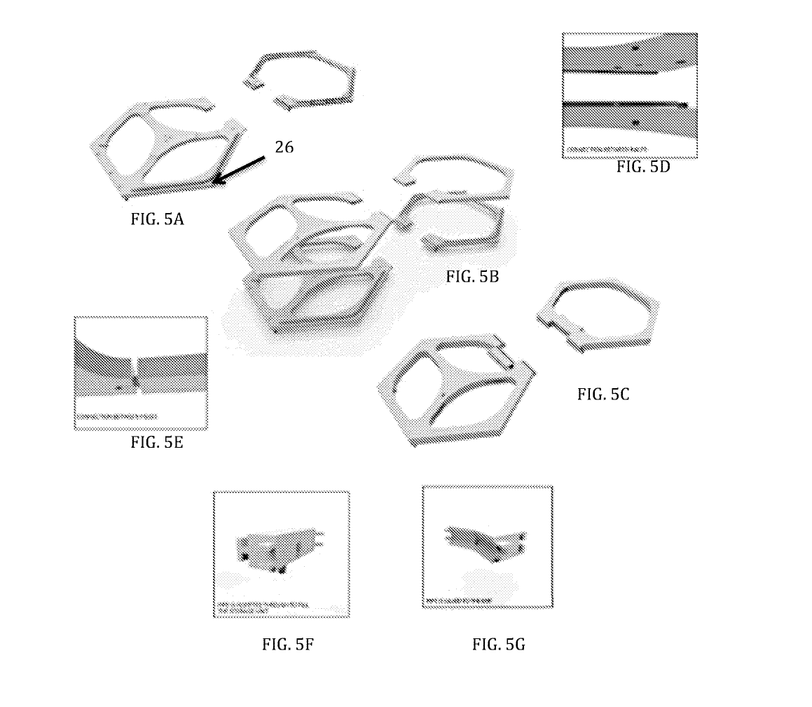

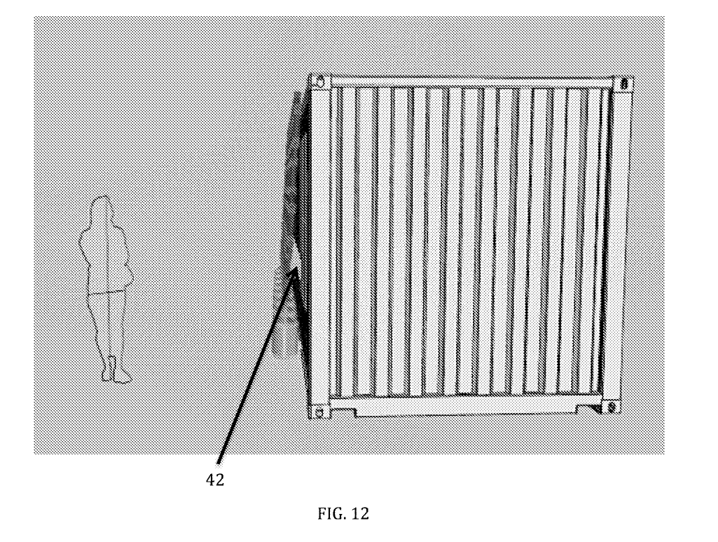

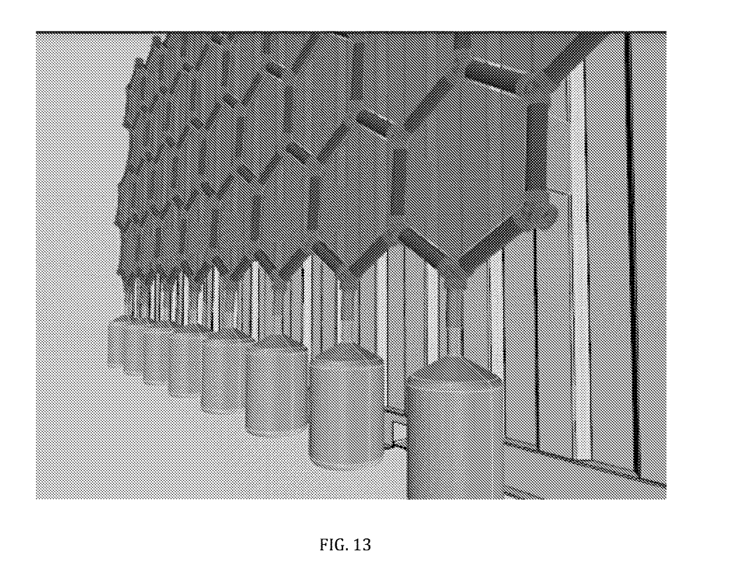

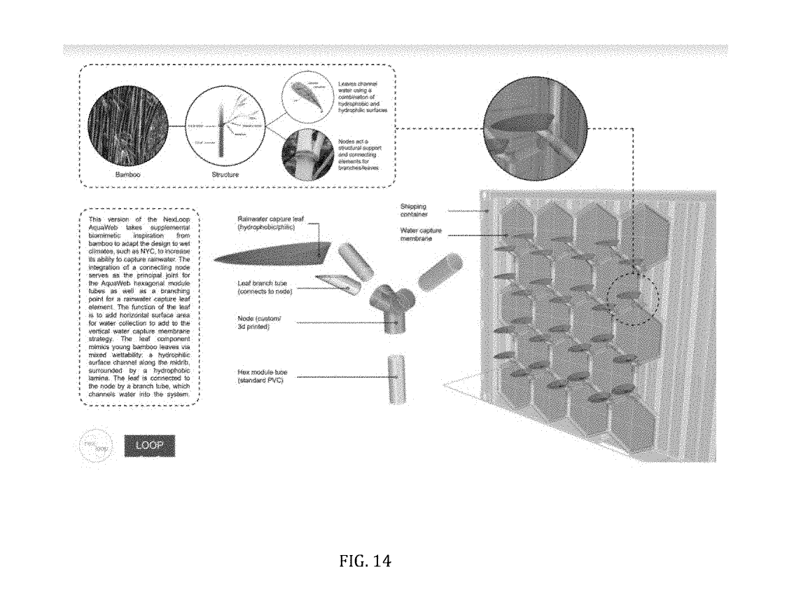

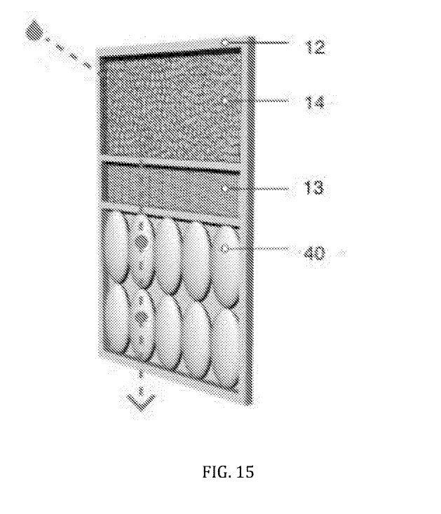

Further features and advantages of the invention, as well as the structure and operation of various embodiments of the invention, are described in detail below with reference to the accompanying FIGS. 1-15.

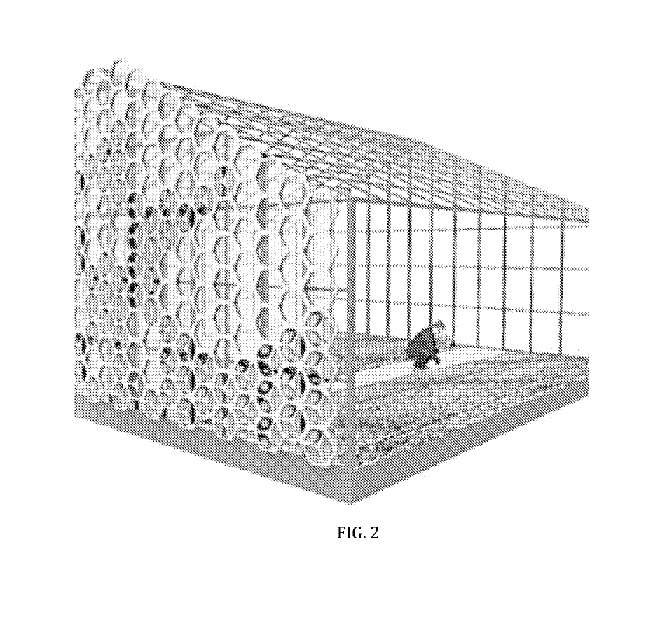

FIG. 1 is a front view of a water collection system 100, according to an embodiment. The water collection system 100 comprises a collection unit 10 and a storage unit 20. While FIG. 1 shows a system 100 comprising one collection unit 10 and one storage unit 20, it should be well understood that the system 100 may comprise any suitable number of collection units 10 and storage units 20. For example, as shown in FIG. 2, the system 100 may include a plurality of interconnected collection units 10 and a plurality of storage units 20. As described in further detail below, the collection units 10 and storage units 20 may be configured to modularly attach to one another as an integrated array that provides a duct system for collecting and transporting atmospheric water. The placement of collection units 10 and storage units 20 may be provided to maximize collection of water surrounding an architectural structure. For example, any number of collection units 10 may be provided near the upper corners of a building or other structure to accommodate higher water accumulation in those areas. Further, any number of water collection units 10 may be placed in series or in parallel to increase the overall efficiency of the system.

The collection unit 10 includes a collection frame 12 and a collection surface 14. The collection surface 14 is configured to capture atmospheric water in an in-situ manner and transport the captured atmospheric water to a periphery of the collection surface, e.g., a lower portion or bottom of the collection surface 14. Atmospheric water includes rainwater, fog, and moisture in the atmosphere surrounding the system 100. The collection surface 14 captures the atmospheric water in an in-situ manner In some embodiments, the collection surface 14 is a mesh material, such as a three-dimensional mesh material, that captures atmospheric water in an in-situ manner

The textile surface structure and/or the fiber pattern of the mesh material may provide sufficient hydrophobicity such that captured atmospheric water is transported along the fibers of the mesh to the outer periphery of the surface 14. The mesh may have a linear woven pattern such that when the mesh is arranged vertically, the water is assisted by gravity to travel downward through the mesh to the lower periphery of the collection surface 14.

The water capture surface 14 is configured to capture and collect atmospheric water from the surrounding atmosphere. The water capture surface 14 may be structured (e.g., through the hydrophobicity and fiber pattern) such that the captured atmospheric water accumulates as droplets on the water capture surface 14. The water capture surface 14 may be structured such that the water droplets increase in size until the droplets fall downward via gravity towards the bottom of the capture surface 14. In some embodiments, the system 100 is configured such that the water droplets flow from the water capture surface 14 to a series of capillaries.

The collection surface 14 may be made of, for example, two-dimensional or three-dimensional woven polyester textiles, meshes, webs, strands, and/or fiber composites. The collection surface may comprise standard plastic foils such as Polyethylene, plastics, bioplastics, biofibers such as flax-based fibers, fibrous materials, and other materials which biomimetic synthetic spider silk. The water capture surface 14 may be a lightweight, hydrophobic, biodegradable 3d woven textile mesh. The water surface capture surface may include any combination of meshes, membranes, and/or coatings: hydrophobic, super hydrophobic, hydrophilic, super hydrophilic, and mixed wettability. The collection surface 14 may employ biomimicry and leverage principles found in nature to collect atmospheric water. These principles include strategies seen in plant surfaces and spider webs, specifically hydrophobicity and hydrophilicity in conjunction with micro scale surface structures and morphologies.

The collection surface 14 may be heated or cooled to create a temperature differential to increase condensation and water collection efficiency. In some embodiments the collection surface 14 may be charged to create an electric field, increasing condensation and increasing water collection efficiency.

In some embodiments, the water capture surface 14 is configured to allow light to pass through it to reach indoor food growing areas (see FIG. 2), while maintaining an appropriate level of UV resistance to avoid material degradation. The water capture surface 14 may combine hydrophobic and hydrophilic properties to maximize water capture and water flow. The water capture surface 14 may comprise hydrophobic or hydrophilic coatings. In some embodiments, the water capture surface 14 created using 3d printing techniques. In some embodiments, the water capture surface 14 has water storage and water filtration capabilities within the single surface. In some embodiments, the water capture surface 14 provides Laplace pressure and/or surface energy gradients to facilitate directional water movement.

The collection unit 10 may include one or more filtration properties or components. For example, the water capture surface 14 may comprise a material the filters the water to remove a substantial portion of debris. Additionally or alternatively, a filter may be provided within the collection frame 12 (e.g., in a lower portion of the collection frame). Additionally or alternatively, a filter may be provided in one or more components of the collection unit 12. Additionally or alternatively, a filter may be provided in an additional or separate component of the system 100.

In some embodiments, the system 100 may include a biomimetic water filtration membrane. The filtration membrane may be integrated with the collection surface (e.g., woven into the three-dimensional mesh) or disposed below the collection surface. The filtration membrane may emulate natural filtration models, such as sea salps, plant xylem membranes, and aquaporins, to remove particulate matter as well as contaminants from the collected water to ensure safe use of the collection water, for example, for agricultural food production. The membrane may comprise a lightweight, transparent or translucent, and biodegradable surface that is incorporated into the system 100. The filtration membrane may filter water that is flowing vertically downward from the water capture surface 14 and into the water storage cavities 24.

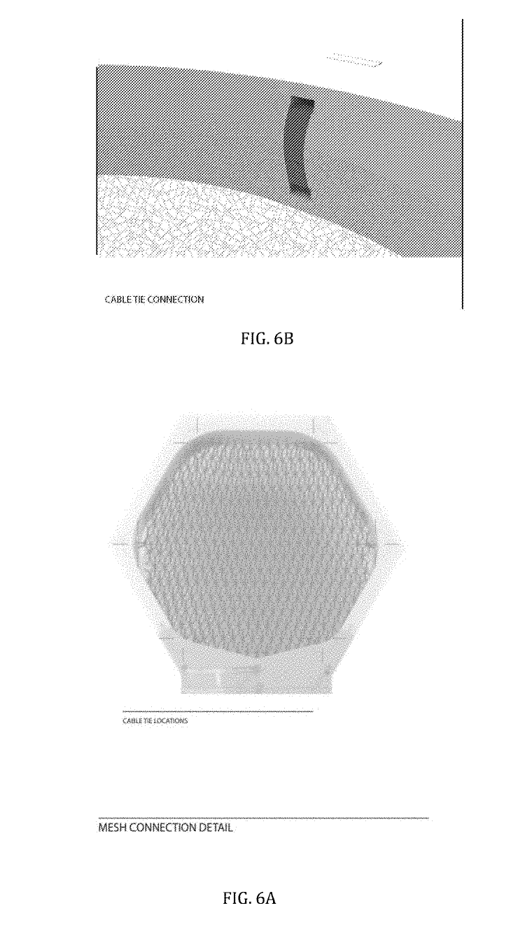

The collection unit 10 may include a collection frame 12 that is configured to support the capture surface. The collection frame 12 may have a frame wall 18 that extends around (e.g., entirely around) the periphery of the capture surface 14. The capture surface 14 may be affixed to the collection frame 12 by any suitable means. FIGS. 6A and 6B show an embodiment in which the capture surface 14 is affixed to the collection frame 12 via cable fasteners 60 that extend through apertures of the frame 12.

The collection frame 12 is configured to attach the capture surface 14 to the storage unit 20. The collection unit 10 and storage unit 20 are configured to engage to allow water to travel from the collection unit 10 to the storage unit 20.

The storage unit 20 includes at least one cavity 24 that is configured for storing the water collected by the capture surface 14 and storage frame 22 for supporting the at least one cavity 24. While FIG. 1 shows three cavities 24, the storage unit 20 may include any suitable number of cavities 24 while remaining within the scope of this disclosure. The cavities 24 may demonstrate biomimetic storage capabilities of the common ice plant's strategy of distributed water storage to create a redundant and resilient system. By implementing multiple small-scale cavities 24 for storing water, the system 100 is modular and scalable and works well in various climates. The storage unit 20 may include a fluidly connected network of lightweight volumes capable of storing water vertically along a building or greenhouse facade. The cavities 24 may vary in size to be optimized for climate and site-specific atmospheric water conditions and water collection to storage necessity in terms of short-term and long-term storage requirements. The water from the cavities 24 may be accessible on demand, e.g., based on food production requirements. The cavities 24 may be made from, for example, thermoplastic foil, membrane sack, flexible plastic, bio plastic membrane, foil sack, rigid plastic, bio plastic container, and/or other biomimetic containers. The cavities 24 may comprise an expandable, durable, and/or biodegradable membrane. In some embodiments, the cavities 24 may be made from recyclable plastic containers. In some embodiments, the cavities 24 may be made from welded plastic sheets, such as ethylene tetrafluoroethylene (ETFE).

As shown in FIGS. 1, 4A-4C and 5A-5G, in some embodiments, water travels from the collection unit 10 to the cavities by way of a conduit 26. The conduit 26 may be disposed within at least one of the collection frame 12 and/or the storage frame 22. The conduit 26 may receive water from the collection surface and transport the water to the cavities 24.

In some embodiments, water collected by the collection surface 24 passively travels through the collection frame 22 for distribution, as shown in FIG. 1. The water may be distributed to other units in a modular array of the system 100 and/or to an exterior storage or distribution component.

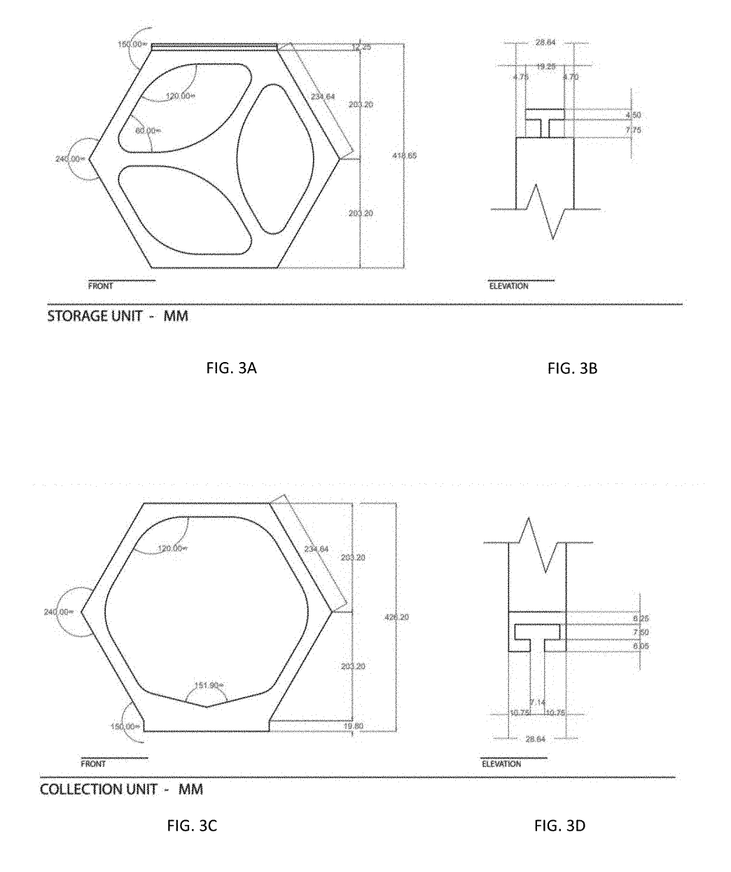

In some embodiments, the collection unit 10 and storage unit 20 are configured to connect with one another to provide a modular array. The collection unit 10 and storage 20 may connect via any suitable means, for example, a mating engagement. As shown in FIGS. 3A-3D, the collection unit 10 and storage 20 may connect through a male/female arrangement, to provide strong stability as well as simple construction assembly.

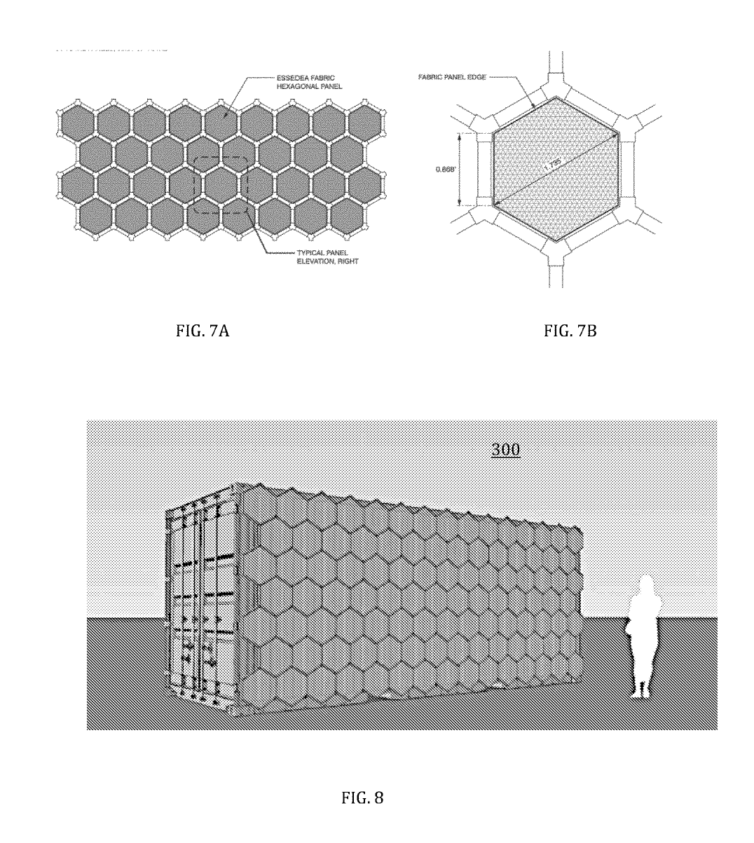

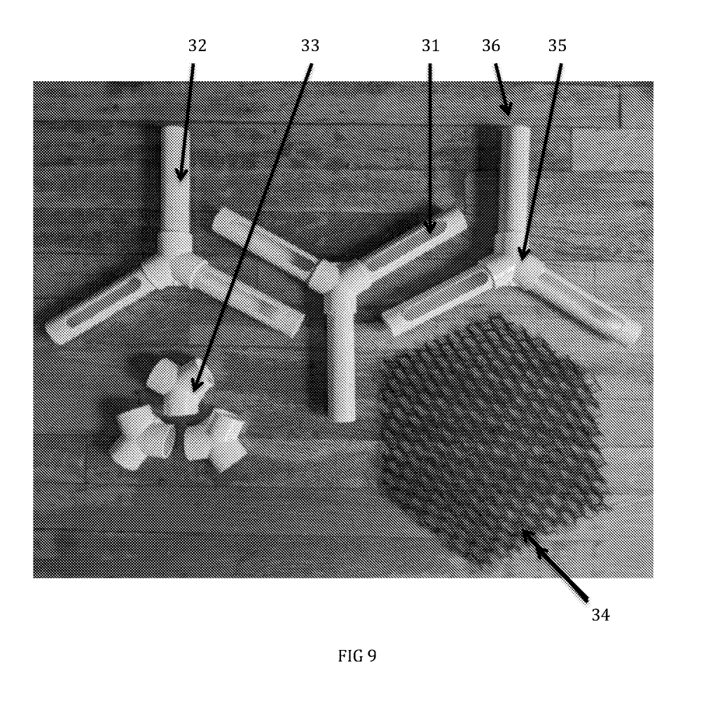

Turning now to FIGS. 7-9, FIG. 7A illustrates a front view of a water collection system 300, and FIG. 7B illustrates a front view of portion-A of the water collection system shown in FIG. 7A, according to an embodiment. FIG. 8 illustrates a perspective view of the water collection system of FIGS. 7A and 7B arranged on an exterior of a shipping container, according to an embodiment. FIG. 9 illustrates a view of disassembled components of a water collection system, according to an embodiment. The water collection system 300 comprises grip-like frame array 32 supporting a plurality of water capture surfaces 34. The frame 32 provides a duct system for collecting, transporting, and distributing the water collected from the water capture surface 34. The water capture surfaces 34 are similar to the water capture surface 14 described above with reference to FIG. 1. The frame 32 may comprise channels 31 and joints 33 that are mechanically and fluidly connected to provide a duct system for transporting the water. Any suitable number of channels 31 and joints 33 may be integrally formed. For example, an integral component 35 may be provided that includes a joint 33 and three channels 31 extending therefrom (see FIG. 9).

The frame 32 is configured to receive water collected by the water capture surface 34. As shown in FIG. 9, one or more of the channels 31 may have an opening 36 extending from a channel interior to a channel exterior. The frame 32 may be arranged such that water travels downward from the water capture surface 34 and through the opening 36 and into the interior of the channels 31. In some embodiments, one or more of the joints 33 may define an opening extending therethrough. In some embodiments, a water filter may be disposed within one or more joint 33. In some embodiments, a water filter may be disposed within one or more channels 31.

The integrated array of channels 31 may transport the water to a collector and/or water distribution system. The water can be transported to any suitable collector and/or water distribution system. For example, the water can be transported to an interior of an architectural structure (e.g., shipping container, building, etc.) for use.

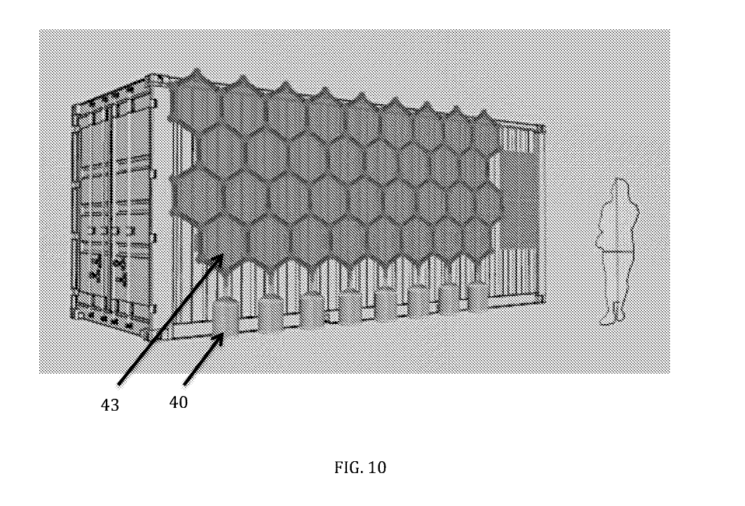

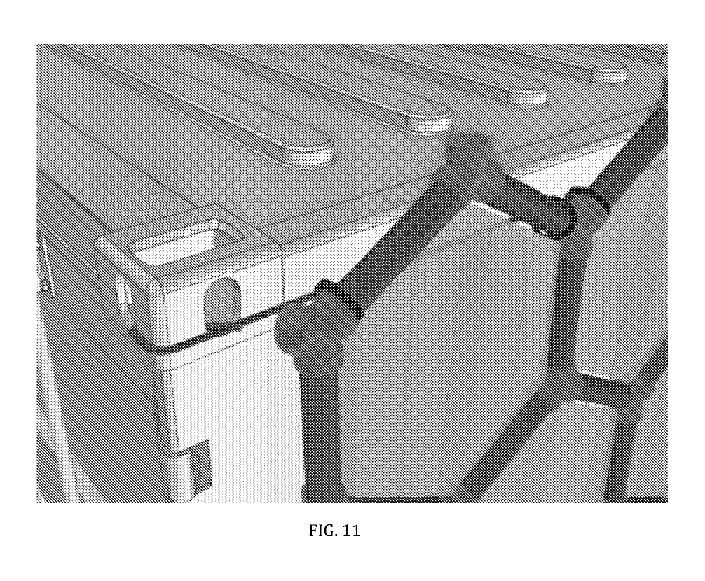

In some embodiments, as shown in FIGS. 10-13, the system 300 may include one or more spacer 42 and/or collection bin 40. The spacers 42 may be configured to separate the capture material 34 from an architectural structure (e.g., building, greenhouse, storage container, etc.) to improve the rear side of the capture material 34's ability to capture water. The collector bin 40 may be provided to accumulate and store the water that is collected by the system 300. The spacers 42 and/or collection bins 40 may be employed with any of the systems described herein, including system 100 described with reference to FIG. 1.

In any of the disclosed embodiments, the collection surface (e.g., 14, 34) and/or the collection frame (e.g., 12, 32) may comprise a conductive material and a low grade charge may be generated across the surface thereof. This polarization may provide greatly increased efficiency of capturing the water by helping water molecules (polar) condense on the collection surface (e.g., mesh) and pulling water molecules that pass through (otherwise lost) back to capture surface. Additionally or alternatively, in any of the disclosed embodiments, conductive materials may be provided to allow for greater control over temperature of the surfaces. For example, conductive materials may cool the collection surface (e.g., 14, 34) and thus increase the condensation of moisture laden air on the capture membrane. Additionally or alternatively, in any of the disclosed embodiments, a superhydrophillic & superhydrophobic coatings may be provided to the collection surface (e.g., 14, 43) to improve wetability.

The above described systems capture and distribute atmospheric water to provide a water supply that can be used for various purposes, including agricultural use and environmental cooling systems.

The systems described herein may be applied (but not limited) to greenhouse or building facades to capture water on vertical surfaces, store water for short and long-term periods, filter water, and distribute water to a food growing area. These systems may be applied to the growing of food for traditional, soil-based growing methods, as well as hydroponic and aquaponic growing methods. The invention comprises an integrated water capture and storage module product, an integrated gravity assisted filtration method for filtering water that travels down vertical surfaces, small-scale distributed and expandable water storage bladders, and a passive water distribution method aided by capillary action, which moves water through the modular system to growing areas.

In some embodiments, the systems described herein may incorporate a “smart” approach, implementing sensor feedback to optimize water distribution and flow through all the parts of the invention. The system may use low-energy methods for moving water or energy gained via water movement through the system, vertically or otherwise. The system may allow for water to be accessed from the modular panels using a tap or spigot and a hose for more of an easier approach to watering crops. The system may utilize low-energy pumps to move water, with energy from solar panels.

The frames may be constructed using any suitable materials, including those that are lightweight, biodegradable, and compatible with food growing and food consumption regulations. In some embodiments, passive movement of water may be done using; flexible or rigid plastic tubing, flexible or rigid bioplastic tubing, flexible or rigid biopastic pipes, polyvinyl chloride (PVC) pipes, 3d printed channels, biofibers such as flax-based fibers, 3d printed filament-like structures, 3d printed hollow and/or solid branch structures, capillary membranes/tubes, biomimetic synthetic spider silk-like materials, fiber composites, fibrous material meshes/webs/strands/fiber, and other 3d printed tube-like and/or pipe-like structures.

The present invention provides numerous advantages such as but not limited as follows:

Off-grid water collection: The present invention collects rainwater so that users do not need to depend on (or reduce their dependence on) municipal systems for watering their crops. Water collection allows farmers to reduce their water and energy bills and in turn produce more inexpensive, locally grown, cleaner food while helping minimize environmental damage from storm water runoff and water waste. This is especially advantageous in regions where water is scarce and expensive.

Locally attuned to biome (arid vs. rainy vs. other) to optimize water collection, an added perk of the present invention is that collection materials are versatile and able to collect water across many biomes—a key advantage is the flexibility and replicability of the NexLoop AquaWeb in many spaces and locations.

Water filtration: The present invention leverages nature for a filtration system to ensure crops are irrigated with pristine rain or other atmospheric water sources. This process ensures that all of the water is clean, safe, and therefore useful for agricultural growing processes. This added advantage to local, sustainable water collection is a key advantage that sets this invention apart from traditional rainwater harvesting systems.

Modular, distributed water storage: the present invention efficiently stores collected water so that water can be used only as needed. A modular, distributed approach creates resiliency in the system and ensure access to water regardless of when the last rainfall happened. This is especially advantageous in regions where water is scarce and expensive.

Passive distribution: Water is distributed to crops passively and on an as—need basis, which reduces energy consumption and costs associated with moving water when it is not necessary and/or continual pumping of water within the system.

Full system integration: While each of the design components individually are innovative; the combination and integrated nesting of the 4 (collection, storage, filtration, and distribution) is a big advantage. Food growers are able to have a single system, which performs based on their needs, and can close the water loop and ensure a more symbiotic food-water nexus. Environmental impact: Closing the water loop allows farmers to decouple from the grid and save both water and electricity—this has significant environmental impact.

Impact on food development: The agricultural sector consumes about 70 percent of renewable freshwater resources globally. The present invention decouples food production from current freshwater resources and, simultaneously, expands safe and clean water.

This invention can be used for water collection for breweries/wineries; larger agricultural operations/fields as part of their irrigation system; places with water shortages and rural areas in undeveloped countries; alternative agriculture operations: containers farms, green roofs, aquaculture/aquaponics, aeropomcs, and vertical farms; and storm water mitigation/collection for other urban spaces and/or coastal regions: parks, streets, and shorelines. The invention can also be used for; soil restoration by introducing/promoting fog drip into soil/landscape, habitat restoration by improving/restoring small water cycles, cooling towers by capturing atmospheric water for cooling, storm water management by slowing down water running off buildings, and as a indoor dehumidifier by capturing humidity for recycling water.

This invention is versatile and can be used in a number of different areas. For example it can be used in both rural and suburban areas. The invention also has the ability to function in a variety of different climate zones for example; temperate climates, wet climates, arid climates, and semi-arid climates. This invention also has the ability to be integrated into a variety of building typologies for example; faccade, rooftop, indoor (Controlled Environment Agriculture), greenhouses, container farms, vertical farms, residential buildings, commercial buidlings, educational buildings, low-rise buildings, mid-rise buildings, high-rise buildings, and freestanding structures.

References throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, refer to the same embodiment.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A system, comprising:
a collection unit comprising;
a capture surface that is configured to capture atmospheric water in an in-situ manner and transport the captured atmospheric water to a periphery of the capture surface, and
a storage unit attached to the collection unit, comprising:
at least one cavity configured for storing the collected water, and
a storage frame, comprising a storage wall that extends around a periphery of the at least one cavity;
wherein the storage frame is fluidly coupled to the collection unit and is configured to transport the collected water from the collection unit to the at least one cavity.

2. The system of claim 1, wherein the capture surface is configured to transport the captured atmospheric water to a lower periphery of the capture surface.

3. The system of claim 1, wherein the capture surface is a woven mesh.

4. The system of claim 1, wherein the capture surface is at least one of hydrophobic, super hydrophobic, hydrophilic, or super hydrophilic.

5. The system of claim 1, wherein the collection unit comprises a water filtration membrane that filters water that is flowing vertically downward from the capture surface.

6. The system, of claim 1, wherein there are two or more cavities.

7. The system of claim 1, wherein the collection unit and storage unit are modular attachable to one another and to a plurality of other collection units and storage units.

8. The system of claim 1, wherein the collection unit further comprises a collection frame that extends around the periphery of the collection surface, the collection frame having a collection channel with a conduit for transporting water, wherein the conduit of the collection frame is fluidly connected to the storage frame.

9. The system of claim 8, wherein the storage wall has a storage channel with a conduit for transporting water, wherein the conduit of the collection frame is fluidly connected to the conduit of the storage frame.

10. The system of claim 9, comprising a plurality of collection units and a plurality of storage units arranged in an array and fluidly connected to one another such that the conduits of the plurality of collection units and the conduits of the plurality of storage units provide a fluidly integrated duct system.

11. A method of assembling a water collection system, comprising:
providing a collection unit, the collection unit comprising a capture surface that is configured to capture atmospheric water in an in-situ manner and transport the captured atmospheric water to a periphery of the capture surface, and
attaching a storage unit to the collection unit, the storage unit comprises:
at least one cavity configured for storing the collected water, and
a storage frame, comprising a storage wall that extends around a periphery of the at least one cavity;
wherein the storage frame is fluidly coupled to the collection unit and is configured to transport the collected water from the collection unit to the at least one cavity.

12. The method of claim 12, wherein the capture surface is hexagonal in shape.

13. The method of claim 12, wherein the capture surface is a woven mesh.

14. The method of claim 12, wherein the capture surface is hydrophobic, super hydrophobic, hydrophilic, or super hydrophilic.

15. The method of claim 12, wherein the collection unit further comprises a water filtration membrane, which filters water that is flowing vertically downward from the capture surface.

16. The method of claim 12, wherein there are two or more cavities.

17. The method of claim 12, wherein the cavities are able to expand.

18. The method of claim 12, wherein the collection unit is affixed to a plurality of other collection units.

19. A system, comprising:
a modular, grid-like frame array comprising a plurality of tubes that define a plurality of interiors,
a plurality of collection surfaces disposed within respective interiors, wherein the collection surfaces are each configured to capture atmospheric water in an in-situ manner and transport the captured atmospheric water to a periphery of the capture surface,
wherein water collection from the collection surfaces flows into an interior conduit of the tubes, and the tubes are fluidly connected to provide an integrated duct system within the modular frame.

20. The system of claim 19, wherein the capture surfaces are configured to transport the captured atmospheric water to a lower periphery of the capture surface.
